(19) United States
(12) Patent Application Publication
(10) Pub. No.: US 2024/0219676 A1
(43) Pub. Date: Jul. 4, 2024

(54) OPTICAL MEMBER DRIVING MECHANISM

(71) Applicant: TDK TAIWAN CORP., Taoyuan City (TW)

(72) Inventors: Kai-Po FAN, Taoyuan City (TW); Man-Ting LU, Taoyuan City (TW); Shou-Jen LIU, Taoyuan City (TW)

(21) Appl. No.: 18/400,551

(22) Filed: Dec. 29, 2023

Related U.S. Application Data
(60) Provisional application No. 63/436,291, filed on Dec. 30, 2022.

(51) Int. Cl. G02B 7/04

(52) U.S. Cl. CPC G02B 7/04

(57) ABSTRACT

An optical member driving mechanism is provided, including a movable portion, a fixed portion, and a driving assembly. The movable portion is configured to connect an optical member, and is movable relative to the fixed portion. The driving assembly is configured to drive the movable portion to move relative to the fixed portion.

### CROSS REFERENCE TO RELATED APPLICATIONS

This application claims the benefit of U.S. Provisional Application No. 63/436,291, filed Dec. 30, 2022, the entirety of which is incorporated by reference herein.

### BACKGROUND OF THE INVENTION

### Field of the Invention

The application relates in general to an optical member driving mechanism, and in particular, to an optical member driving mechanism for driving an optical member to move.

### Description of the Related Art

As technology has advanced, a lot of electronic devices (for example, tablet computers and smartphones) have been given the functionality of taking photographs and recording video. These electronic devices have become more commonplace, and have been developed to be more convenient and thin. More and more choices are provided for users to choose from.

### BRIEF SUMMARY OF INVENTION

An embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move relative to the fixed portion.

In some embodiments, the driving assembly includes a first circuit component and a second circuit component, the first circuit component has an annular structure, and the second circuit component is connected to the first circuit component, wherein an included angle is formed between the first circuit component and the second circuit component, and the included angle is greater than 0 degrees and less than 180 degrees.

In some embodiments, the movable portion includes a holder, and the driving assembly includes a first electromagnetic driving member, a second electromagnetic driving member, and a third electromagnetic driving member that are disposed on different sides, wherein the holder is disposed between the third electromagnetic driving member and the second circuit component, and the thickness of the third electromagnetic driving member along an optical axis of the optical member is less than the thickness of the first electromagnetic driving member along the optical axis.

In some embodiments, the thickness of the third electromagnetic driving member along the optical axis is less than the thickness of the second electromagnetic driving member along the optical axis.

In some embodiments, the movable portion includes a frame, and the driving assembly includes a magnetically permeable member embedded in the frame.

In some embodiments, the magnetically permeable member includes a first plate portion, a second plate portion, and a third plate portion, the first plate portion is disposed between the first electromagnetic driving member and the frame, the second plate portion is disposed between the second electromagnetic driving member and the frame, and the third plate portion is disposed between the third electromagnetic driving member and the frame.

In some embodiments, the third plate portion is substantially perpendicular to the first plate portion and the second plate portion.

In some embodiments, the magnetically permeable member further includes a connecting portion connected to the first plate portion, the second plate portion, and the third plate portion, wherein the connecting portion and the first plate portion form an L-shaped cross-section, and the portion of the connecting portion that is connected to the third plate portion is coplanar with the third plate portion.

In some embodiments, a through hole is formed on the first plate portion, and the frame has a protruding portion accommodated in the through hole.

In some embodiments, when viewed along the optical axis, the magnetically permeable member forms an enclosed region.

In some embodiments, the first circuit component has a first engaging portion, the second circuit component has a second engaging portion, the first engaging portion is engaged with the second engaging portion. Of the first engaging portion and the second engaging portion, one includes a protrusion, and the other includes a depression.

In some embodiments, the first engaging portion has a first surface, a second surface, and a third surface, the first surface faces the second circuit component, the second surface faces away from the second circuit component, and the third surface is connected to the first surface and the second surface, wherein the second engaging portion has a fourth surface, a fifth surface, and a sixth surface, the fourth surface faces the first circuit component, the fifth surface is connected to the fourth surface, and the sixth surface is connected to the fourth surface and opposite to the fifth surface, wherein metal is coated on the first surface, the second surface, the third surface, the fourth surface, the fifth surface, and the sixth surface.

In some embodiments, the first circuit component and the second circuit component are integrally formed as one piece.

In some embodiments, the movable portion includes a frame, the first circuit component and the second circuit component are disposed on the frame, and a gap is formed between the frame and the connection point of the first circuit component and the second circuit component.

In some embodiments, the movable portion includes a frame, the frame has a recess, and the second circuit component is accommodated in the recess and exposed from an opening of the recess.

In some embodiments, the opening is located at the upper surface of the frame.

In some embodiments, the frame has at least one positioning portion protruding from an inner wall of the recess.

In some embodiments, the movable portion includes a frame, and the frame has a positioning portion protruding from the upper surface of the frame, wherein a surface of the positioning portion facing the first circuit component corresponds to an appearance of the first circuit component.

In some embodiments, the driving assembly further includes a control member and a magnetic shield member, the control member and the magnetic shield member are disposed on the second circuit component, and the second circuit component is disposed between the control member and the magnetic shield member, wherein the dimensions of the magnetic shield member are greater than the dimensions of the control member, and when viewed along a direction that is perpendicular to an optical axis of the optical member, the magnetic shield member covers the control member.

In some embodiments, the movable portion includes a holder and a frame, and the driving assembly includes a first circuit component, a second circuit component, a control member, an inner elastic member, an outer elastic member, a supporting member, a first electromagnetic driving element, and a circuit assembly. The second circuit component is disposed on the frame and connected to the first circuit component. The control member is disposed on the second circuit component. The inner elastic member is connected to the holder and the frame. The outer elastic member is connected to the frame. The supporting member is connected to the outer member and the fixed portion. The first electromagnetic driving element is disposed on the holder. The circuit assembly is embedded in the fixed portion. The control member is electrically connected to the first electromagnetic driving element through the second circuit component, the first circuit component, and the inner elastic member in sequence. The control member is electrically connected to the circuit assembly through the second circuit component, the first circuit component, the outer elastic member, and the supporting member in sequence.

### BRIEF DESCRIPTION OF DRAWINGS

The invention can be more fully understood by reading the subsequent detailed description and examples with references made to the accompanying drawings, wherein:

FIG. 1 is a schematic diagram of an optical member driving mechanism, an electronic device, and an optical member according to an embodiment of the invention;

FIG. 2 is a schematic diagram of the optical member driving mechanism according to an embodiment of the invention;

FIG. 3 is an exploded-view diagram of the optical member driving mechanism according to an embodiment of the invention;

FIG. 4 is a cross-sectional view taken along the line A-A in FIG. 2;

FIG. 5 is a schematic diagram of the optical member driving mechanism according to an embodiment of the invention, wherein an housing thereof is omitted;

FIG. 6 is a cross-sectional view taken along the line B-B in FIG. 2;

FIG. 7 is a cross-sectional view taken along the line C-C in FIG. 2;

FIG. 8 is a schematic diagram of a magnetically permeable member according to an embodiment of the invention;

FIG. 9 is a partial cross-sectional view of the optical member driving mechanism according to an embodiment of the invention; and

FIG. 10 is a partial cross-sectional view of the optical member driving mechanism according to another embodiment of the invention.

### DETAILED DESCRIPTION OF INVENTION

The making and using of the embodiments of the optical member driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

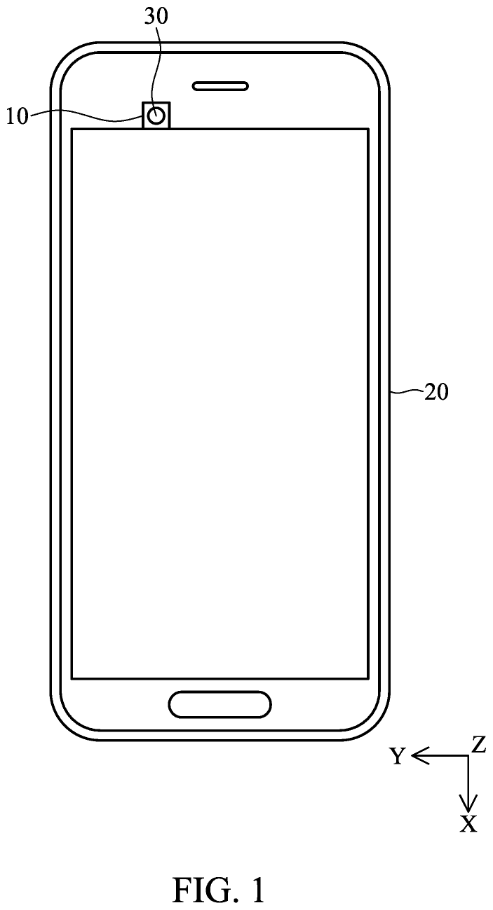

Referring to FIG. 1, an optical member driving mechanism 10 according to an embodiment of the invention can be disposed in an electronic device 20. The optical member driving mechanism 10 can be configured to hold and drive an optical member 30, so that the optical member 30 can move relative to an image sensor (not shown) in the electronic device 20, and the purpose of focusing, zooming, and/or optical image stabilization (OIS) can be achieved. For example, the electronic device 20 can be a smartphone, a tablet computer, or a digital camera, and the optical member 30 can be a camera lens with a plurality of lenses, but it is not limited thereto.

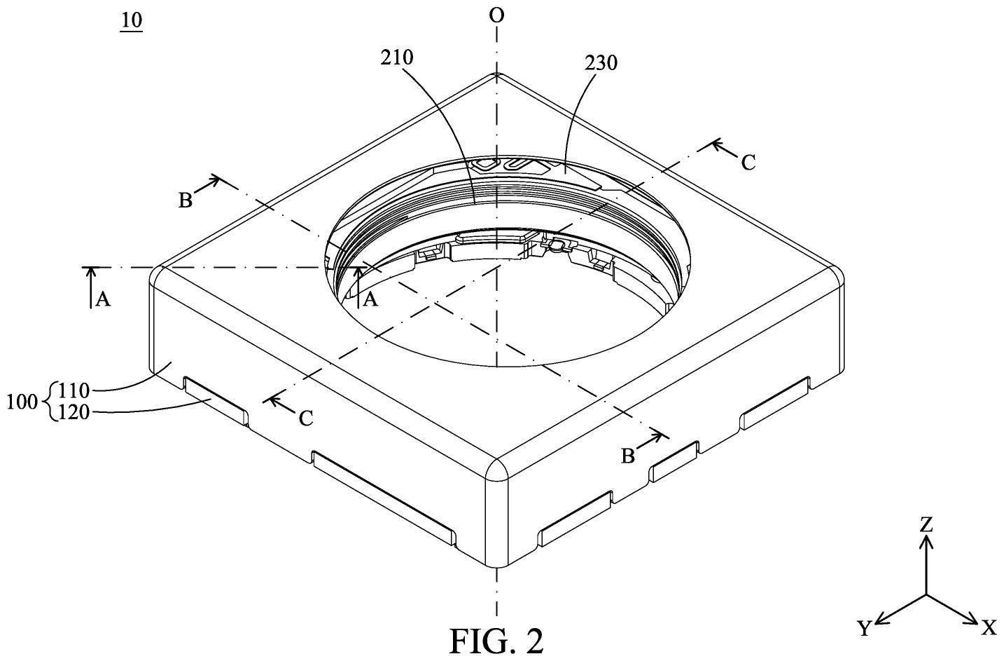

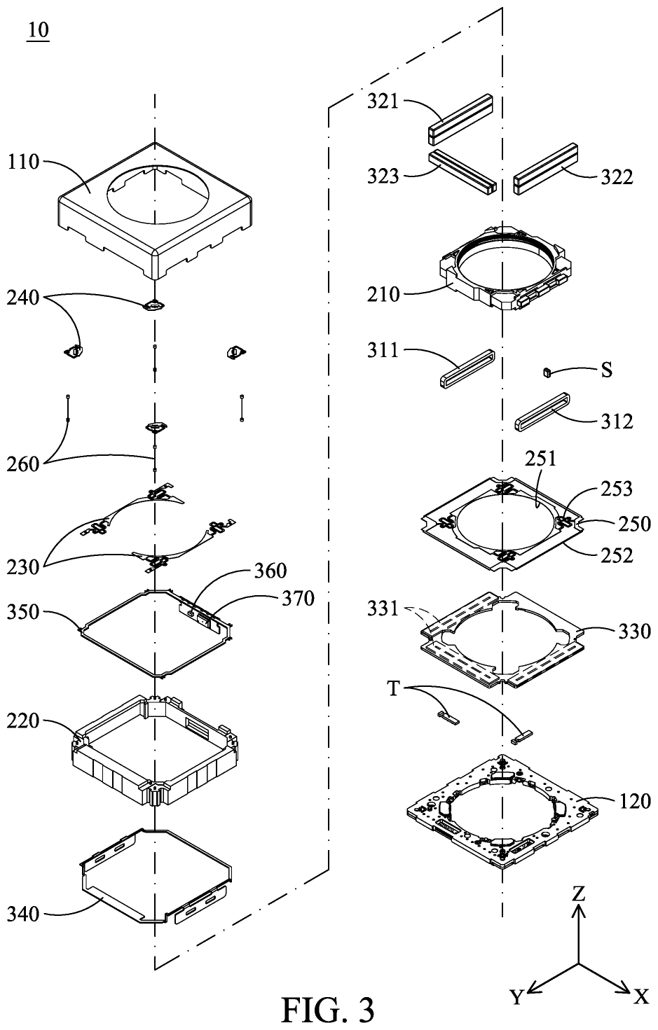

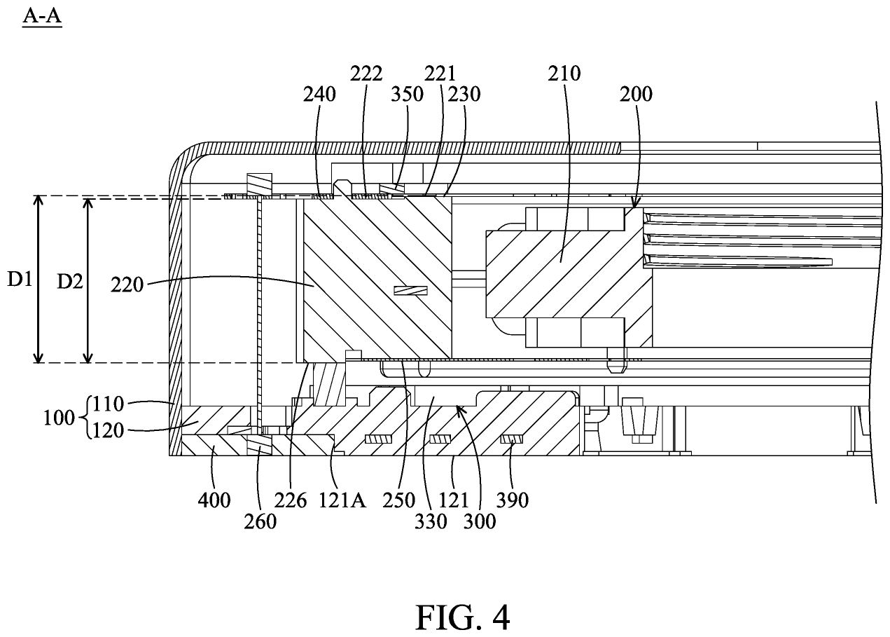

FIG. 2 is a schematic diagram of the optical member driving mechanism 10, FIG. 3 is an exploded-view diagram of the optical member driving mechanism 10, and FIG. 4 is a cross-sectional view taken along the line A-A in FIG. 2. As shown in FIG. 2 to FIG. 4, the optical member driving mechanism 10 primarily includes a fixed portion 100, a movable portion 200, and a driving assembly 300.

The fixed portion 100 includes a housing 110 and a base 120. The housing 110 and a base 120 can be engaged with each other by at least one adhesive member 400 to form a hollow box. The movable portion 200 and the driving assembly 300 can be accommodated in the hollow box formed by the housing 110 and the base 120, so that the fixed portion 100 can protect the movable portion 200 and the driving assembly 300.

At least one recess 121A can be formed on a bottom surface 121 of the base 120. The adhesive member 400 can be accommodated in the recess 121A and in contact with the housing 110 and the base 120 to engage them. In this embodiment, the adhesive member 400 is merely exposed from the bottom of the optical member driving mechanism 10, so that other electronic components right beside the optical member driving mechanism 10 can be prevented from attaching to the adhesive member 400.

The movable portion 200 includes a holder 210, a frame 220, a plurality of inner elastic members 230, a plurality of outer elastic members 240, a lower elastic member 250, and a plurality of supporting members 260. The holder 210 is configured to hold the optical member 30, and can be movably connected to the frame 220 by the inner elastic members 230 and the lower elastic member 250.

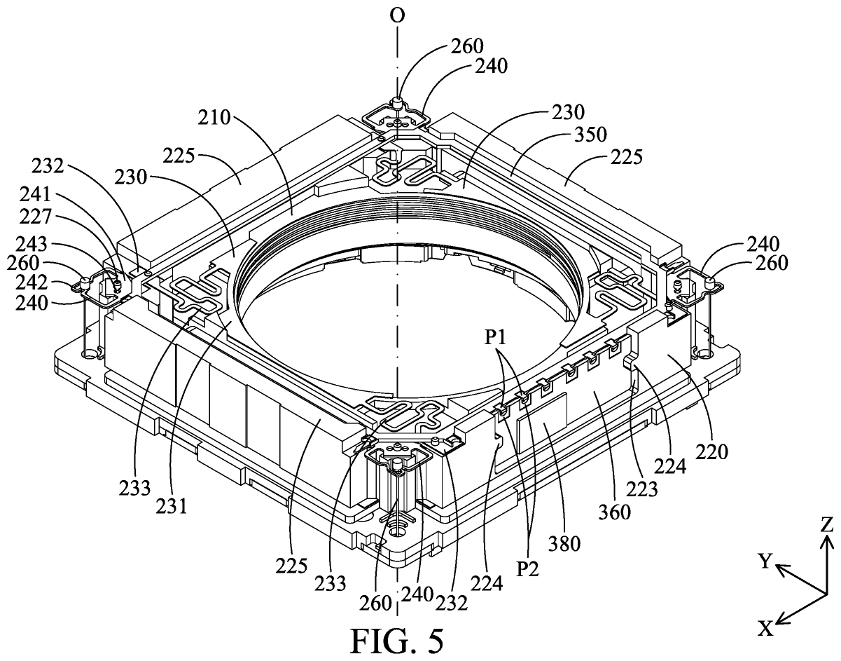

In detail, as shown in FIG. 3 to FIG. 5, each of the inner elastic members 230 includes at least one holder fixing section 231, at least one frame fixing section 232, and at least one string section 233. The holder fixing section 231 is connected to the upper surface of the holder 210, the frame fixing section 232 is connected to the upper surface of the frame 220, and the string section 233 is disposed between the holder fixing section 231 and the frame fixing section 232 and connected to them. Similarly, the lower elastic member 250 includes at least one holder fixing section 251, at least one frame fixing section 252, and at least one string section 253. The holder fixing section 251 is connected to the lower surface of the holder 210, the frame fixing section 252 is connected to the lower surface of the frame 220, and the string section 253 is disposed between the holder fixing section 251 and the frame fixing section 252 and connected to them. Therefore, the holder 210 can be hung in the frame 220.

The frame 220 can be movably connected to the base 120 by the outer elastic members 240 and the supporting members 260. Each of the outer elastic members 240 has a fixed section 241 and a free section 242. The fixed section 241 is affixed to the upper surface of the frame 220. The free section 242 is connected to the fixed section 241 and protrudes from the lateral surface of the frame 220. Each of the supporting members 260 has a longitudinal structure extending along the optical axis O of the optical member 30. One end of each supporting member 260 is affixed to the free section 242 of the outer section member 240, and the other end of each supporting member 260 is affixed to the base 120 of the fixed portion 100. For example, each supporting member 260 includes a suspension wire that is elastic, but it is not limited thereto.

In this embodiment, each outer elastic member 240 has a hole 243 formed on the fixed section 241 thereof. The frame 220 has a protruding portion 227 passing through the hole 243 and accommodated in the hole 243. The dimensions of the hole 243 can be greater than the dimensions of the protruding portion 227, therefore, when the user uses the glue to affix the fixed section 241 to the frame 220, the contact area of the glue can be increased and the reliability can be enhanced. The outline of at least a portion of the hole 243 can correspond to the appearance of the protruding portion 227, so that the positioning of each outer elastic member 240 can be facilitated.

The inner elastic members 230 and the outer elastic members 240 can be electrically connected to the driving assembly 300, so that they can be a path configured to transmit the current. Specifically, the inner elastic members 230 can be separated from the outer elastic members 240, and the thickness of each inner elastic member 230 along the optical axis O can be different from the thickness of each outer elastic member 240 along the optical axis O (for example, the thickness of each inner elastic member 230 can be less than the thickness of each outer elastic member 240). Thus, the inner elastic members 230 and the outer elastic members 240 can provide current paths independently and can provide different elastic forces.

Moreover, the surface of the frame 220 connected to the inner elastic members 230 can be defined as a first connecting surface 221, and the surface of the frame 220 connected to the outer elastic member 240 can be defined as a second connecting surface 222. The distance D1 between the first connecting surface 221 and the lower surface 226 of the frame 220 can be different to the distance D2 between the second connecting surface 222 and the lower surface 226 of the frame 220. Therefore, the top surfaces of the inner elastic members 230 and the outer elastic members 240 can be coplanar, and the placement of other member in the optical driving mechanism 10 (such as the driving assembly 300) can be facilitated.

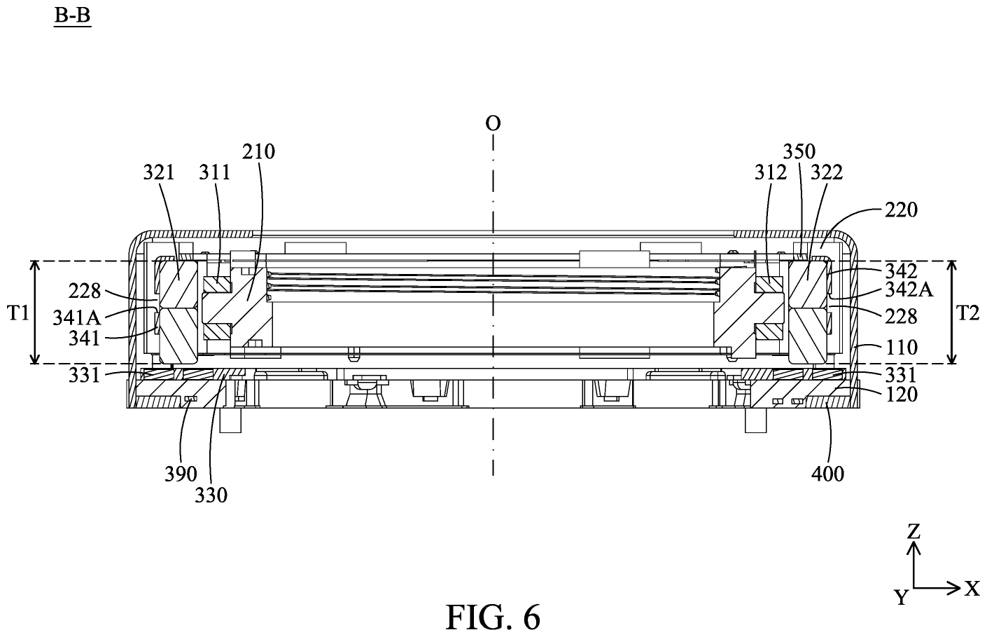

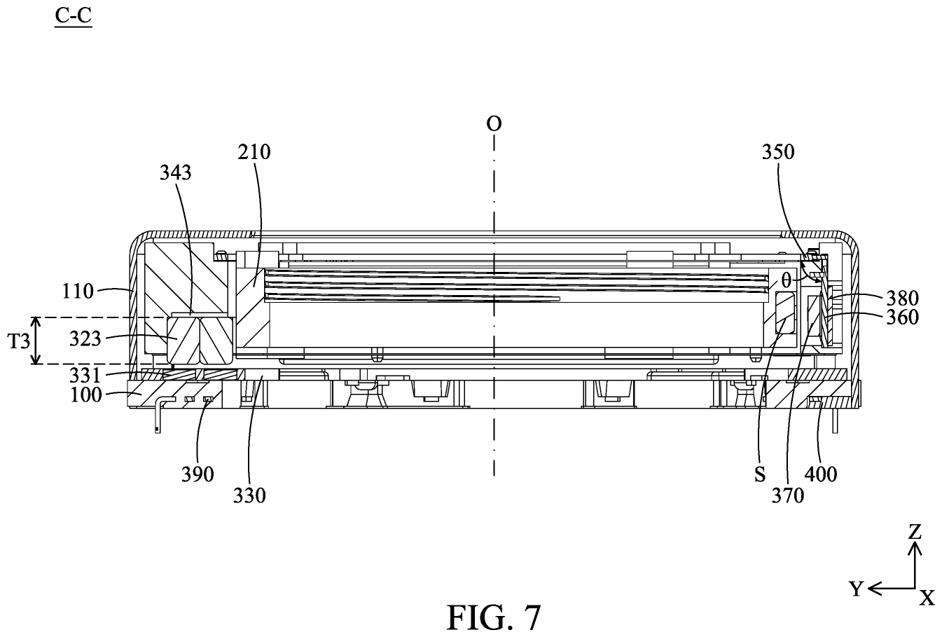

FIG. 6 is a cross-sectional view taken along the line B-B in FIG. 2, and FIG. 7 is a cross-sectional view taken along the line C-C in FIG. 2. As shown in FIG. 3, FIG. 6, and FIG. 7, the driving assembly 300 includes a first electromagnetic driving element 311, a second electromagnetic driving element 312, a first electromagnetic driving member 321, a second electromagnetic driving member 322, a third electromagnetic driving member 323, a coil plate 330, and a magnetically permeable member 340.

The first electromagnetic driving element 311 and the second electromagnetic driving element 312 are disposed on the holder 210, and respectively situated at the opposite sides of the holder 210. The first electromagnetic driving member 321 and the second electromagnetic driving member 322 are disposed on the frame 220. The position of the first electromagnetic driving member 321 corresponds to the position of the first electromagnetic driving element 311, and the position of the second electromagnetic driving member 322 corresponds to the position of the second electromagnetic driving element 312.

For example, each of the first electromagnetic driving element 311 and the second electromagnetic driving element 312 can be a coil, and each of the first electromagnetic driving member 321 and the second electromagnetic driving member 322 can be a magnet. When current flow through the first electromagnetic driving element 311 and the second electromagnetic driving element 312, the electromagnetic effect between the first electromagnetic driving element 311 and the first electromagnetic driving member 321 and the electromagnetic effect between the second electromagnetic driving element 312 and the second electromagnetic driving member 322 can provide driving force to push the holder 210 to move relative to the frame 220 along the optical axis O of the optical member 30. Therefore, the purpose of zooming or focusing can be achieved.

The third electromagnetic driving member 323 is disposed on the frame 220, and the first electromagnetic driving member 321, the second electromagnetic driving member 322, and the third electromagnetic driving member 323 are disposed on different sides of the holder 210. The coil plate 330 is disposed on the base 120, and has a plurality of coils 331 corresponding to the first electromagnetic driving member 321, the second electromagnetic driving member 322, and the third electromagnetic driving member 323.

When current flow through the coils 331 of the coil plate 330, the electromagnetic effect between the coils 331 and the first, second, and third electromagnetic driving members 321, 322, and 323 can provide driving force to push the frame 220 to move relative to the frame 220 along a direction that is perpendicular to the optical axis O of the optical member 30 (such as along the X-axis and/or the Y-axis). The holder 210 connected to the frame 220 can move accordingly, therefore, the purpose of optical image stabilization can be achieved.

In this embodiment, the direction of the magnetic field lines inside the third electromagnetic driving member 323 is different from the direction of the magnetic field lines inside the first electromagnetic driving member 321 and the second electromagnetic driving member 322, and the thickness T3 of the third electromagnetic driving member 323 along the optical axis O of the optical member 30 is less than the thickness T1 of the first electromagnetic driving member 321 and the thickness T2 of the second electromagnetic driving member 322 along the optical axis O of the optic member 30.

The magnetically permeable member 340 can be embedded in the frame 220, and at least a portion of the magnetically permeable member 340 can be disposed between the first, second, third electromagnetic driving members 321, 322. 323 and the frame 220 to enhance the driving effect of the optical member driving mechanism 10.

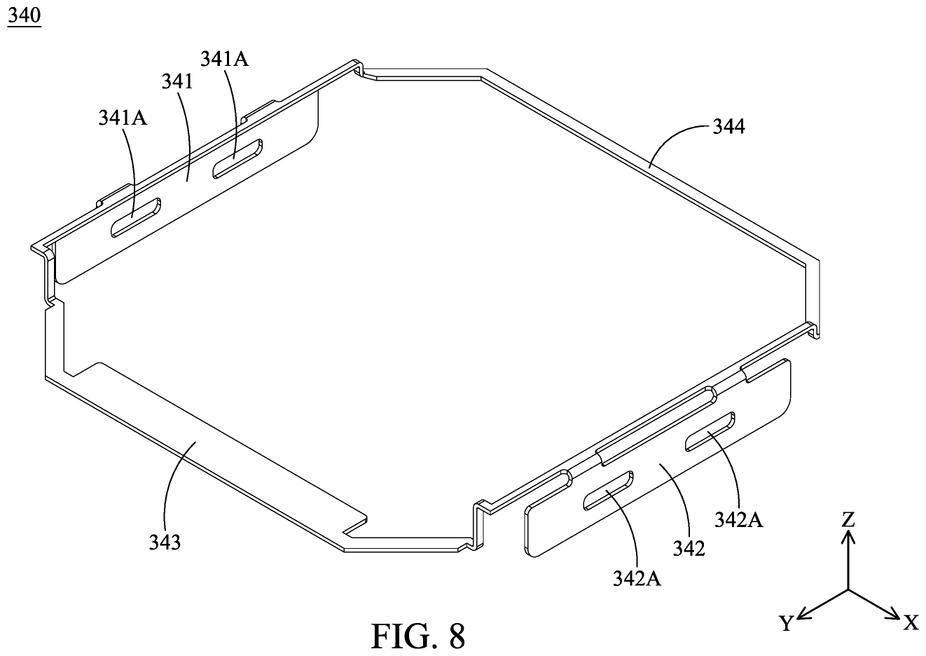

In particular, as shown in FIG. 6 to FIG. 8, the magnetically permeable member 340 can include a first plate portion 341, a second plate portion 342, a third plate portion 343, and a connecting portion 344. The first plate portion 341 is disposed between the first electromagnetic driving member 321 and the frame 220. The first plate portion 341 has at least one through hole 341A, and the frame 220 has a protruding portion 228. This protruding portion 228 passes through the through hole 341A to position the first plate portion 341. The second plate portion 342 is disposed between the second electromagnetic driving member 322 and the frame 220. The second plate portion 342 has at least one through hole 342A, and frame has another protruding portion 228. This protruding portion 228 passes through the through hole 342A to position the second plate portion 342. The third plate portion 343 is disposed between the third electromagnetic driving member 323 and the frame 220. The connecting portion 344 is connected to the first plate portion 341, the second plate portion 342, and the third plate portion 343.

Specifically, the third plate portion 343 is substantially perpendicular to the first plate portion 341 and the second plate portion 342. The connecting portion 344 and the first plate portion 341 can form an L-shaped cross-section. The portion of the connection portion 344 connected to the third plate portion 343 is coplanar with the third plate portion 343. When viewed along the optical axis O of the optical member 30, the magnetically permeable member 340 can form an enclosed region, and the holder 210 is situated in the enclosed region.

Referring to FIG. 3 to FIG. 7, in this embodiment, the driving assembly 300 further includes a first circuit component 350, a second circuit component 360, a control member 370, a magnetic shield member 380, and a circuit assembly 390. The first circuit component 350 can be a circuit board. The first circuit component 350 is affixed to the frame 220 and has an annular structure. When viewed along the optical axis O of the optical member 30, the first circuit component 350 surrounds the holder 210. In particular, the first circuit component 350 is affixed to the frame fixing sections 232 of the inner elastic members 230 and the fixed sections 241 of the outer elastic members 240 (for example, via soldering or using the screw or the rivet to engage). Therefore, the inner elastic members 230 and the outer elastic members 240 can be electrically connected to the first circuit component 350.

Similarly, the second circuit component 360 can be a circuit board. The second circuit component 360 is disposed on the frame 220, and the holder 210 is disposed between the second circuit component 360 and the third electromagnetic driving member 323. The second circuit component 360 can be electrically connected to the first circuit component 350, and an included angle θ can be formed between the second circuit component 360 and the first circuit component 350. The included angle θ is greater than 0 degrees and less than 180 degrees. In this embodiment, the included angle θ between the second circuit component 360 and the first circuit component 350 is about 90 degrees.

In detail, the first circuit component 350 includes at least one first engaging portion P1, and the second circuit component 360 includes at least one second engaging portion P2. The user can use the solder to connect the first engaging portion P1 to the second engaging portion P2, so that the first engaging portion P1 and the second engaging portion P2 can be engaged with each other. Of the first engaging portion P1 and the second engaging portion P2, one includes a protrusion, and the other includes a depression. When the first circuit component 350 and the second circuit component 360 are engaged, the protrusion is accommodated in the depression.

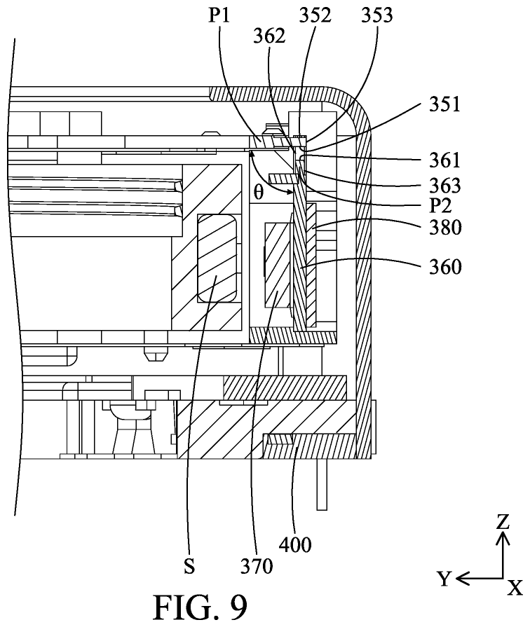

As shown in FIG. 9, the first engaging portion P1 has a first surface 351, a second surface 352, and a third surface 353. The first surface 351 faces the second circuit component 360, the second surface 352 faces away from the second circuit component 360, and the third surface 353 is disposed between the first surface 351 and the second surface 352 and connected them. The second engaging portion P2 has a fourth surface 361, a fifth surface 362, and a sixth surface 363. The fourth surface 361 faces the first circuit component 350. The fifth surface 362 and the sixth surface 363 are connected to the fourth surface 361, and the fifth surface 362 is opposite to the sixth surface 363. Metal (such as gold) is coated on the first, second, third surfaces 351, 352, and 353 and the fourth, fifth, and sixth surfaces 361, 362, and 363, so as to facilitate the soldering and prevent the oxidation.

Referring to FIG. 3 to FIG. 7, the second circuit component 360 is accommodated in a recess 223 of the frame 220. The opening of the recess 223 is located at the upper surface of the frame 220, and the second circuit component 360 is exposed from the opening to facilitate the user to solder. Furthermore, the frame 220 further includes at least one positioning portion 224 and at least one positioning portion 225. The positioning portion 224 protrudes from the inner wall of the recess 223 and corresponds to the appearance of the second circuit component 360, so as to position the second circuit component 360. The positioning portion 225 protrudes from the upper surface of the frame 220. The surface of the positioning portion 225 facing the first circuit component 350 corresponds to the appearance of the first circuit component 350, so as to position the first circuit component 350.

The control member 370 is disposed on the second circuit component 360 and configured to control the movement of the movable portion 200 relative to the fixed portion 100. The control member 370 can be electrically connected to the first electromagnetic component 311 and the second electromagnetic component 312 through the second circuit component 360, the first circuit component 350, and the inner elastic members 230 in sequence. The control member 370 can be electrically connected to the circuit assembly 390 that is embedded in the base 120 through the second circuit component 360, the first circuit component 350, the outer elastic members 240, and the supporting members 260 in sequence. The circuit assembly 390 is configured to electrically connect the coils 331 of the coil plate 330, the electronic member T (such as the sensor or the driver IC) disposed on the base 120, and/or the external circuit in the electronic device 20.

The magnetic shield member 380 is disposed on the second circuit component 360, and the second circuit component 360 is disposed between the control member 370 and the magnetic shield member 380. The dimensions of the magnetic shield member 380 are greater than the dimensions of the control member 370. When viewed along the direction that is perpendicular to the optical axis O (such as the Y-axis), the magnetic shield member 380 covers the control member 370. Therefore, the driving effect of the driving assembly 300 can be enhanced.

In this embodiment, the driving assembly 300 further includes a sensing object S, and the control member 370 is an all-in-one driver IC. That is, there is a sensor in the control member 370. The sensing object S can be disposed on the holder 210, and the position of the sensing object S can correspond to the control member 370.

The control member 370 can detect the position of the sensing object S to obtain the position of the holder 210 relative to the frame 220. For example, the sensor in the control member 370 can be a Hall sensor, a magnetoresistance effect sensor (MR sensor), a giant magnetoresistance effect sensor (GMR sensor), a tunneling magnetoresistance effect sensor (TMR sensor), or a fluxgate sensor, but it is not limited thereto.

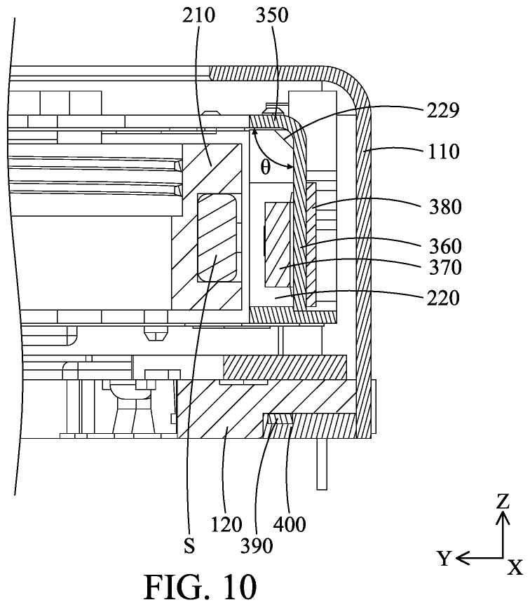

Referring to FIG. 10, in another embodiment of the invention, the first circuit component 350 and the second circuit component 360 can be integrally formed as one piece, and can form the included angle θ, which is greater than 0 degrees and less than 180 degrees, between the first circuit component 350 and the second circuit component 360 by bending. In order to prevent the first circuit component 350 or the second circuit component 360 from contacting the corner of the frame 220 and causing the damage, the frame 220 can include a chamfer 229, and a gap can be formed between the frame 220 and the connection point between the first and second circuit components 350 and 360.

In summary, an embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move relative to the fixed portion.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical member driving mechanism, comprising:
a movable portion, configured to connect an optical member;
a fixed portion, wherein the movable portion is movable relative to the fixed portion; and
a driving assembly, configured to drive the movable portion to move relative to the fixed portion.

2. The optical member driving mechanism as claimed in claim 1, wherein the driving assembly comprises a first circuit component and a second circuit component, the first circuit component has an annular structure, and the second circuit component is connected to the first circuit component, wherein an included angle is formed between the first circuit component and the second circuit component, and the included angle is greater than 0 degrees and less than 180 degrees.

3. The optical member driving mechanism as claimed in claim 2, wherein the movable portion comprises a holder, and the driving assembly comprises a first electromagnetic driving member, a second electromagnetic driving member, and a third electromagnetic driving member that are disposed on different sides, wherein the holder is disposed between the third electromagnetic driving member and the second circuit component, and a thickness of the third electromagnetic driving member along an optical axis of the optical member is less than a thickness of the first electromagnetic driving member along the optical axis.

4. The optical member driving mechanism as claimed in claim 3, wherein the thickness of the third electromagnetic driving member along the optical axis is less than a thickness of the second electromagnetic driving member along the optical axis.

5. The optical member driving mechanism as claimed in claim 3, wherein the movable portion comprises a frame, and the driving assembly comprises a magnetically permeable member embedded in the frame.

6. The optical member driving mechanism as claimed in claim 5, wherein the magnetically permeable member comprises a first plate portion, a second plate portion, and a third plate portion, the first plate portion is disposed between the first electromagnetic driving member and the frame, the second plate portion is disposed between the second electromagnetic driving member and the frame, and the third plate portion is disposed between the third electromagnetic driving member and the frame.

7. The optical member driving mechanism as claimed in claim 6, wherein the third plate portion is substantially perpendicular to the first plate portion and the second plate portion.

8. The optical member driving mechanism as claimed in claim 6, wherein the magnetically permeable member further comprises a connecting portion connected to the first plate portion, the second plate portion, and the third plate portion, wherein the connecting portion and the first plate portion form an L-shaped cross-section, and a portion of the connecting portion that is connected to the third plate portion is coplanar with the third plate portion.

9. The optical member driving mechanism as claimed in claim 6, wherein a through hole is formed on the first plate portion, and the frame has a protruding portion accommodated in the through hole.

10. The optical member driving mechanism as claimed in claim 5, wherein when viewed along the optical axis, the magnetically permeable member forms an enclosed region.

11. The optical member driving mechanism as claimed in claim 2, wherein the first circuit component has a first engaging portion, the second circuit component has a second engaging portion, and the first engaging portion is engaged with the second engaging portion, wherein of the first engaging portion and the second engaging portion, one includes a protrusion, and the other includes a depression.

12. The optical member driving mechanism as claimed in claim 11, wherein the first engaging portion has a first surface, a second surface, and a third surface, the first surface faces the second circuit component, the second surface faces away from the second circuit component, and the third surface is connected to the first surface and the second surface, wherein the second engaging portion has a fourth surface, a fifth surface, and a sixth surface, the fourth surface faces the first circuit component, the fifth surface is connected to the fourth surface, and the sixth surface is connected to the fourth surface and opposite to the fifth surface, wherein metal is coated on the first surface, the second surface, the third surface, the fourth surface, the fifth surface, and the sixth surface.

13. The optical member driving mechanism as claimed in claim 2, wherein the first circuit component and the second circuit component are integrally formed as one piece.

14. The optical member driving mechanism as claimed in claim 13, wherein the movable portion comprises a frame, the first circuit component and the second circuit component are disposed on the frame, and a gap is formed between the frame and a connection point of the first circuit component and the second circuit component.

15. The optical member driving mechanism as claimed in claim 2, wherein the movable portion comprises a frame, the frame has a recess, and the second circuit component is accommodated in the recess and exposed from an opening of the recess.

16. The optical member driving mechanism as claimed in claim 15, wherein the opening is located at an upper surface of the frame.

17. The optical member driving mechanism as claimed in claim 15, wherein the frame has at least one positioning portion protruding from an inner wall of the recess.

18. The optical member driving mechanism as claimed in claim 2, wherein the movable portion comprises a frame, and the frame has a positioning portion protruding from an upper surface of the frame, wherein a surface of the positioning portion facing the first circuit component corresponds to an appearance of the first circuit component.

19. The optical member driving mechanism as claimed in claim 2, wherein the driving assembly further comprises a control member and a magnetic shield member, the control member and the magnetic shield member are disposed on the second circuit component, and the second circuit component is disposed between the control member and the magnetic shield member, wherein dimensions of the magnetic shield member are greater than dimensions of the control member, and when viewed along a direction that is perpendicular to an optical axis of the optical member, the magnetic shield member covers the control member.

20. The optical member driving mechanism as claimed in claim 1, wherein the movable portion includes a holder and a frame, and the driving assembly comprises:
a first circuit component;
a second circuit component, disposed on the frame and connected to the first circuit component;
a control member, disposed on the second circuit component;
an inner elastic member, connected to the holder and the frame;
an outer elastic member, connected to the frame;
a supporting member, connected to the outer member and the fixed portion;
a first electromagnetic driving element, disposed on the holder, wherein the control member is electrically connected to the first electromagnetic driving element through the second circuit component, the first circuit component, and the inner elastic member in sequence; and
a circuit assembly, embedded in the fixed portion, wherein the control member is electrically connected to the circuit assembly through the second circuit component, the first circuit component, the outer clastic member, and the supporting member in sequence.
